(19) United States
(12) Patent Application Publication
(10) Pub. No.: US 2018/0289218 A1
(43) Pub. Date: Oct. 11, 2018

(54) OSCILLATING BLADE FOOD PROCESSOR WITH CUTTING ACCESSORIES

(71) Applicant: Spectrum Brands, Inc., Middleton, WI (US)

(72) Inventors: Joseph Valdon Krebs, Madison, WI (US); Rolando Antonio Cavazos Jimenez, Middleton, WI (US)

(21) Appl. No.: 15/769,533

(22) PCT Filed: Oct. 20, 2016
(86) PCT No.: PCT/US2016/057834

§ 371 Date: Apr. 19, 2018

Related U.S. Application Data
(60) Provisional application No. 62/243,800, filed on Oct. 20, 2015.

(51) Int. Cl. A47J 43/07; A47J 43/25

(52) U.S. Cl. CPC A47J 43/0722; A47J 43/255

(57) ABSTRACT

The invention described herein is directed to a food processing assembly having an upright or tower configuration with a blade support member and a blade member engaged with a top portion of the tower. In one example embodiment, the food processing assembly is configured to process food received in an inlet chute using a blade assembly located on the blade member that is operated in an oscillating mode.

### CLAIM OF PRIORITY

This application claims priority to and the benefit of a U.S Provisional Application with Ser. No. 62/243,800, filed on Oct. 20, 2015, which is incorporated herein by reference in its entirety.

### FIELD AND BACKGROUND OF THE INVENTION

The invention described herein relates to food processing devices and to mechanical and handheld food cutting devices.

There are food processing apparatus of the type having a working bowl or jug or jar with a motor-driven shaft projecting vertically upwards through the bottom of the bowl. Various selected rotary tools can be engaged with and driven by the shaft for performing many different food processing operations as may be desired by the user. A detachable cover or lid is usually secured over the top of the bowl during use. The cover typically includes a chute or feed tube which has a mouth that opens downwardly through the cover into the top of the bowl. The food items to be prepared or processed may be placed in the chute and then are manually pushed down through the top chute into the bowl by means of a removable pusher or plunger member which is adapted to slide down into the inlet chute in the manner of a plunger. For further information and examples about this type of food preparing apparatus reference is made to U.S. Pat. Nos. 5,921,485 and 7,159,808.

A number of food processing units, such as motor base driven base models or tower/upright models with motors in the upright base, typically come with interchangeable rotary tools which may be used in the food processor including slicing discs, shredding discs, grating discs, etc. which have a disc-like cutting tool member formed of sheet metal, preferably stainless steel, or plastic, with one or more cutting elements projecting above the upper surface of the cutting disc member. These various disc-like cutting members are generally positioned in the top of the bowl near the lower surface of the cover where they can cut, slice, shred, or grate the food items entering downwardly from the chute into the top of the bowl. For the purpose of positioning the cutting discs at or near the top of the bowl, such a rotary tool may include a relatively long hollow hub or shaft extending relatively far down into the bowl, depending upon the height of the motor-driven tool shaft in the bowl. Thus, each of the various cutting disc members can be engaged quickly and easily with the shaft in a positive driving relationship and also can be removed quickly and conveniently to be replaced by another. One type of food preparation is the cutting of vegetables, such as a tomato into slices or onions in to slices or into a diced form. Examples of slicing or grating discs of the prior art are shown in U.S. Pat. No. 4,877,191 which has a horizontal blade spaced above the plane of the disc and is well suited for slicing a cucumber, carrot or potato into slices of uniform thickness.

In the tower or upright mixer models, such as the KitchenAid® Professional series mixers, the motor is located in the upper portion of the tower unit with a gear structure located near cone-style blades that provide various types of cuts. The upright model typically includes a catch or mixing bowl that captures the cut or processed food. However, one of the challenges has been to process foods quickly and efficiently without having to change blades from cutting and dicing blades to shredding and slicing blades while using an automatic food processor that is easy to use and to clean. It would therefore be advantageous to have an apparatus that would provide for various automatic food processing cuts with an easy to use food processor and motor configuration.

### SUMMARY

The invention described herein discloses a unique food processor assembly and system exhibiting an oscillating mode for processing foodstuffs. In a related embodiment, counter and storage space is saved when using a single blade member populated with multiple blade assemblies with the motor driven drive shaft housed in a tower unit. The single blade member can also be used to make various cuts of food without using other blade members or requiring any disassembly to replace blades. An advantage to this form factor is that the single food cutting accessory (blade member and blade support member) can simply be put into the dishwasher for cleaning while the rest of the food processor remains virtually clean. Once the user is done with the food cutting assembly, it can also be easily stored away with any other cutting blades of the food processor.

In one example embodiment, there is provided a food processing device that includes a food processor tower having a base and a top portion that extends vertically from the base, the tower including a motor and drive shaft assembly configured to oscillate a drive shaft axially about a longitudinal axis of the drive shaft in an oscillating mode, and a motor control switch located on the tower to actuate the motor. The food processing device further includes a blade support member coupled to the top portion of the tower, the blade support frame member having an inlet chute disposed on an upper surface of the blade support member and an outlet chute disposed under the blade support member. The food processing device also includes a blade member having a blade assembly disposed thereon and supported by the blade support member, the blade member removably engaged with the drive assembly in the top portion of the tower, wherein the blade member and motor drive shaft assembly process food received at the inlet chute as the blade member is being oscillated axially by the motor and directs processed food through the outlet chute and wherein the blade member oscillates independent of the blade support member.

In one example embodiment, there is provided a food processor tower having a base, an upright portion and a top portion disposed on the upright portion, the tower including a motor and drive shaft assembly configured to oscillate a drive shaft axially in an oscillating mode about a longitudinal axis of the drive shaft, and a motor control switch located on the tower to actuate the motor; a blade support member coupled to the top portion of the tower and angled away from the upright portion, the blade support frame member having an inlet chute disposed on an upper surface of the blade support member and an outlet chute disposed under the blade support member. The food processor also having a blade member having a blade assembly disposed thereon and supported within the blade support member, the blade member removably engaged with the drive shaft in the top portion of the tower, wherein the blade member and motor drive shaft assembly process food received at the inlet chute as the blade member is being oscillated axially by the motor and directs processed food through the outlet chute and wherein the blade member oscillates independent of the blade support member.

In another example embodiment, there is provided a food processing assembly having a substantially disc-shaped blade member having a center portion and at least two blade assemblies disposed on a surface of the blade member, wherein each of the blade assemblies extends from about the center portion towards an edge of the disc-shaped blade member.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### DESCRIPTION OF THE DRAWINGS

Other important objects and advantages of the invention will be apparent from the following detailed description of the invention taken in connection with the accompanying drawings in which:

FIG. 1 illustrates a right side view of an improved food processing assembly including a food processing tower with an integrated motor, a circular blade and a blade support frame having an inlet and outlet chute and bowl in accordance with the invention; and

FIG. 2 illustrates a top view of the circular blade of FIG. 1 divided into four equally sized quadrants, each quadrant illustrating at least one blade assembly in accordance with the invention.

### DETAILED DESCRIPTION OF THE INVENTION

The following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

The various embodiments of the invention are directed to an oscillating food processor assembly having an upright or tower configuration with a blade support member and a blade member engaged with a top portion of the tower. In one particular embodiment, the food processing assembly is configured to process food received in an inlet chute using a blade assembly located on the blade member that is operated in an oscillating mode.

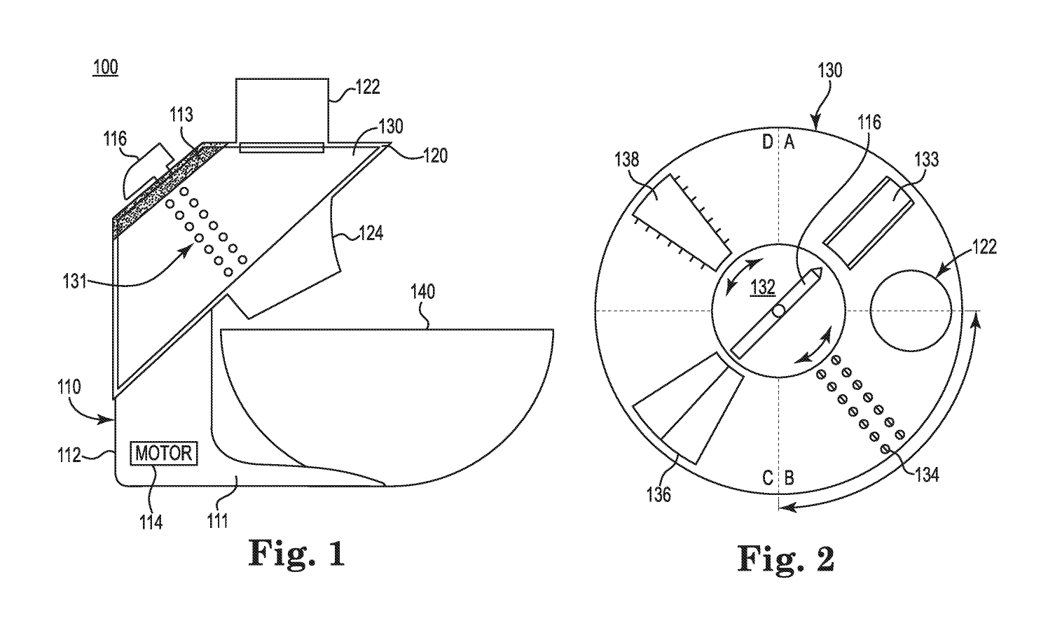

Referring now to the figures, FIG. 1 a right side view of an improved food processing assembly 100 including a food processing tower 110 having a base 112, an upright member 113, an integrated motor 114 located in tower 110 with a motor control switch 111 for actuating the motor in an oscillating mode, a top portion 115 that supports a circular blade support member 120 and a circular blade member 130 that is engaged with a drive shaft assembly in tower 110. In this example embodiment, circular blade support member 120 includes an inlet chute 122 on the surface of member 120 and an outlet chute 134 protruding underneath therefrom and directing cut or processed food into a bowl 140. In this example embodiment, tower portion 110 includes motor 114 and a drive shaft assembly (not shown; located in top portion 115) configured to oscillate a drive shaft (not shown) axially about a longitudinal axis of the drive shaft in an oscillating mode (see both bidirectional arrows in FIG. 2).

Further, in this example embodiment, a mode cutting selector switch 116 is located on the top of tower 110 to select the cutting mode of blade member 130. In one example embodiment, blade member 130 is supported by blade support member 120 and includes at least one blade assembly 131 disposed thereon. Blade member 130 is removably engaged with the drive assembly in top portion 115 of the tower such that the blade member 130 and the motor drive shaft assembly process food received at inlet chute 122 as blade member 130 is being oscillated axially by motor 114 and directing processed food through outlet chute 124. In this example embodiment, blade member 130 oscillates independent of blade support member 120. Referring again to FIG. 1, blade support member 120 and blade member 130 are substantially concave (similar to a cone) in configuration and blade member 130 is in a concentric relationship with and located within blade support member 120. In this example embodiment, blade member 130 has a center portion 132 by which the blade member is supported by the drive shaft at an angle (open end angled away from the tower) and is supported such that blade assembly 131 is aligned under inlet chute 122 of blade support member 120 and aligned with outlet chute 124.

In this example embodiment, top portion 115 of the tower includes food processing (or mode cutting) selector switch 116 for selecting, for instance, a blade assembly 131 on blade member 130, selector switch 116 being configured to rotate blade member 130 axially to a selected blade assembly to be aligned under inlet chute 122. Upon actuation, the motor and drive assembly oscillate circular blade member 130 (as shown) axially under inlet chute 122 such that the axial movement of the circular blade member (see arrow in center portion of blade member 130 in FIG. 2) is limited to within a portion of the blade surface, which in this example is a quadrant portion of the blade member. In this example embodiment, the oscillating mode can be continuous or in a pulse mode, depending on the user. In a related embodiment, in food processing assembly 100, motor 114 and the drive shaft assembly are configured to rotate the blade member in a continuous (or pulse) rotating mode. In this example embodiment, the motor is preferably a conventional electric motor and is operatively engaged with and oscillates the outwardly extending drive shaft protruding from the base or from the top portion of tower 110. In this example embodiment, blade support member 120 and chutes 122 and 124 are made of transparent or translucent plastic but can also be made of glass, such as Pyrex® brand of glass, or ceramic, molded polymeric or PTFE material and may be constructed of nearly any rigid, structural material that is able to take on the general shape of the blade support member and chutes.

Referring now to FIG. 2 illustrates one example embodiment of a top view of circular blade member 120 of FIG. 1 divided into four equally sized quadrants A, B, C and D, with each quadrant having thereon at least one blade assembly (133, 134, 136 and 138) in accordance with the invention. In one example embodiment, blade member 130 is comprised of at least four quadrants, wherein each quadrant includes at least one of a slicing blade assembly 133, a shredding (or grating) blade assembly 134, a dicing blade assembly 136 and a Julienne blade assembly 138. In one specific example, in quadrant A, a longitudinal portion of slicing blade assembly 133 and an opening extend radially from about center portion 132 of blade member 130 towards an edge of the blade member. In this example embodiment, when blade member 130 is mounted in a food processing apparatus, such as in FIG. 1 or in a standard food processor with a bowl or jar, a cover lid and motor in the base configuration, it is rotatable axially about a longitudinal axis that is through center portion 132 so as to be aligned under inlet chute 122 of blade support member 120. In this example, each quadrant of blade member 130 is configured to be aligned under the inlet chute of the blade support member 120 depending on the type of cut or food processing that the user wants. The bidirectional arrow in center portion 132 and the bidirectional arrow on the perimeter or outside of blade member 130 indicate that blade member 130 is configured for oscillating or back and forth movement. In this example embodiment, the oscillating movement is limited to movement within each quadrant so as to achieve the desired processing of food items.

In a related embodiment, blade member 130 is configurable to oscillate between each of two sections or halves, each with a particular blade assembly, such that blade member 130 is oscillated within each half or section. In yet another example embodiment, blade member is configured to divide the cutting surface into 3 equidistant portions. In yet another related embodiment, blade member 130 and the motor assembly is configurable to increase the number of portions and blade assemblies formed on the surface of the blade member and are not just limited to 2 halves or 4 quadrants.

In a related example embodiment, a food processing accessory or blade member 130 is provided comprised of a substantially disc-shaped blade member having a center portion 132 and at least two blade assemblies disposed on a surface of the blade member. In this example embodiment the blade assemblies extends from about the center portion towards an edge of the disc-shaped blade member. In this example embodiment, the surface of the blade member is divided into two equidistant sections or halves and each of blade assemblies is located within each section or half. In yet another related embodiment, the surface of blade member is subdivided into 3 equidistant sections, with each section having a different blade assembly. In a related embodiment, the blade assemblies are selected from the group consisting of a slicing assembly, a shredding assembly, a grating assembly and a dicing assembly.

In this example embodiment, blade support member 120, inlet chute 122 and outlet chute 124 of food cutting assembly 100 are preferably constructed of molded polymeric or PTFE material and may be constructed of nearly any rigid, structural material that is able to take on the general shape of the blade support member. Blade support member 120, in this example embodiment is secured via an interlock to the top portion of tower 112 with food processing assembly 130 being mounted onto the drive shaft located at the top portion of tower 112. Once the food processor motor 112 is turned on and set to the desired oscillating mode (in a related embodiment, the motor can be turn on a desired rotational speed so as to begin rotation of food cutting assembly 120), the user can then urge the first foodstuff or vegetable downwardly through inlet chute 122 and towards blade member 120 with blade assembly 131 preferably using a pusher to do so, so as to begin the processing of the first foodstuff.

In a related embodiment, blade member 130 is configurable for use in a standard food processing arrangement that uses a jar or bowl, a cover lid with an inlet chute and a motor with drive shaft (protruding upwards into the bowl and up from the base) located in a food processing base with the motor controls located thereon. In related embodiments, blade member 130 can be a cone shape, a disc shape or a drum shape as well. Where blade member 130 is in the shape of a drum, in a related embodiment, the blade assemblies can either be located at the top of the drum or on the side (if it is shaped as a cylinder drum) and have a side inlet chute. In this example embodiment, the drum blade member is engaged with the drive shaft at the bottom of the processor and oscillated similar to a disc blade.

The foregoing specific embodiments of the present invention as set forth in the specification herein are for illustrative purposes only. Various deviations and modifications may be made within the spirit and scope of the invention without departing from the main theme thereof.

What is claimed is:

1. A food processing assembly comprising:
a food processor tower having a base and a top portion that extends vertically from the base, the tower including a motor and drive shaft assembly configured to oscillate a drive shaft axially about a longitudinal axis of the drive shaft in an oscillating mode, and a motor control switch located on the tower to actuate the motor;
a blade support member coupled to the top portion of the tower, the blade support frame member having an inlet chute disposed on an upper surface of the blade support member and an outlet chute disposed under the blade support member; and
a blade member having a blade assembly disposed thereon and supported by the blade support member, the blade member removably engaged with the drive assembly in the top portion of the tower;
wherein the blade member and motor drive shaft assembly process food received at the inlet chute as the blade member is being oscillated axially by the motor and directs processed food through the outlet chute and wherein the blade member oscillates independent of the blade support member.

2. The food processing assembly of claim 1 wherein the blade support member and the blade member are substantially concave in configuration and wherein the blade member is in a concentric relationship with and located within the blade support member.

3. The food processing assembly of claim 2, wherein the blade member has a center portion by which the blade member is supported by the drive shaft at an angle and wherein the blade assembly is aligned under the inlet chute of the blade support member.

4. The food processing assembly of claim 3 wherein a longitudinal portion of the blade assembly and an opening extend radially from about the center portion of the blade member towards an edge of the blade member.

5. The food processing assembly of claim 1 wherein a surface of the blade member includes more than one blade assembly, the blade member rotatable axially about a longitudinal axis through a center portion of the blade member to be aligned under the inlet chute of the blade support frame member.

6. The food processing assembly of claim 5 wherein the blade member is comprised of at least two halves, wherein each half includes at least one of a slicing blade assembly, a shredding blade assembly, a grating blade assembly and a dicing blade assembly, and wherein each half is configured to be aligned under the inlet chute of the blade support frame member.

7. The food processing assembly of claim 5 wherein the top portion of the tower includes a food processing selector switch for selecting a blade assembly on the blade member, the selector switch configured to rotate the blade member axially to a selected blade assembly to be aligned under the inlet chute.

8. The food processing assembly of claim 5 wherein the motor and drive assembly oscillate a circular blade member under the inlet chute, wherein the movement of the circular blade member is limited to within at least a portion of the blade member.

9. The food processing assembly of claim 5 wherein the blade member is comprised of at least four quadrants, wherein each quadrant includes at least one of a slicing blade assembly, a shredding blade assembly, a grating blade assembly and a dicing blade assembly, and wherein each quadrant is configured to be aligned under the inlet chute of the blade support frame member.

10. The food processing assembly of claim 1, wherein the blade support member is supported by the top portion of the tower and the blade member is supported by the drive shaft in an angled position such that food received at the inlet chute is directed through the blade member to the outlet chute.

11. A food processing assembly comprising:
a food processor tower having a base, an upright portion and a top portion disposed on the upright portion, the tower including a motor and drive shaft assembly configured to oscillate a drive shaft axially in an oscillating mode about a longitudinal axis of the drive shaft, and a motor control switch located on the tower to actuate the motor;
a blade support member coupled to the top portion of the tower and angled away from the upright portion, the blade support frame member having an inlet chute disposed on an upper surface of the blade support member and an outlet chute disposed under the blade support member; and
a blade member having a blade assembly disposed thereon and supported within the blade support member, the blade member removably engaged with the drive shaft in the top portion of the tower;
wherein the blade member and motor drive shaft assembly process food received at the inlet chute as the blade member is being oscillated axially by the motor and directs processed food through the outlet chute and wherein the blade member oscillates independent of the blade support member.

12. The food processing assembly of claim 11 wherein a surface of the blade member includes more than one blade assembly, the blade member rotatable axially about a longitudinal axis through a center portion of the blade member to be aligned under the inlet chute of the blade support frame member.

13. The food processing assembly of claim 12 wherein the blade member is comprised of at least two halves, wherein each half includes at least one of a slicing blade assembly, a shredding blade assembly, a grating blade assembly and a dicing blade assembly, and wherein each half is configured to be aligned under the inlet chute of the blade support frame member.

14. The food cutting assembly of claim 12 wherein the top portion of the tower includes a food processing selector switch for selecting a blade assembly on the blade member, the selector switch configured to rotate the blade member axially to a selected blade assembly aligned under the inlet chute.

15. The food cutting assembly of claim 11 wherein a longitudinal portion of the blade assembly and an opening extend radially from about the center portion of the blade member towards an edge of the blade member.

16. A food processing assembly comprising:
a substantially disc-shaped blade member having a center portion and at least two blade assemblies disposed on a surface of the blade member, wherein each of the blade assemblies extends from about the center portion towards an edge of the disc-shaped blade member.

17. The food processing assembly of claim 16 wherein the surface of the blade member is divided into two equidistant halves and wherein each blade assembly is located within each half.

18. The food processing assembly of claim 16 wherein the surface of the blade member is divided into four equidistant quadrants and wherein each of blade assembly is located within each quadrant.

19. The food processing assembly of claim 18 wherein the blade assembly for each of the halves is selected from the group consisting of a slicing assembly, a shredding assembly, a grating assembly and a dicing assembly.

20. The food processing assembly of claim 16 wherein the disc-shaped blade member has a concave configuration with the blade assemblies disposed on an outside surface of the disc-shaped blade member.
